(19) United States
(12) Patent Application Publication
(10) Pub. No.: US 2016/0231576 A1
(43) Pub. Date: Aug. 11, 2016

(54) COLLIMATED LIGHTING EFFECT FOR AN AUTOMATED LUMINAIRE

(71) Applicant: ROBE LIGHTING, INC., Sunrise, FL (US)

(72) Inventors: Pavel JURIK, Postredni Becva (CZ); Josef VALCHAR, Postredni Becva (CZ)

(73) Assignee: ROBE LIGHTING SRO, Austin, TX (US)

(21) Appl. No.: 15/024,115

(22) PCT Filed: Mar. 10, 2015
(86) PCT No.: PCT/US2015/019745

§ 371 Date: Mar. 23, 2016

Related U.S. Application Data
(60) Provisional application No. 61/950,395, filed on Mar. 10, 2014.

(51) Int. Cl. G02B 27/14; F21V 14/04; F21V 13/04; F21V 14/06; F21V 7/00; G02B 5/28

(52) U.S. Cl. CPC G02B 27/141; F21V 7/0066; G02B 5/28; F21V 13/04; F21V 14/06; F21V 14/04; F21W 2131/406

(57) ABSTRACT

This specification describes an multiparameter automated luminaire employing an improved laser optical module which expands the width of the laser light beam emitted from the laser module combined with a conventional light optical engine.

### RELATED APPLICATION

This application claims priority of U.S. Provisional Application No. 61/950,395 filed on 10 Mar. 2014.

### TECHNICAL FIELD OF THE INVENTION

The present invention generally relates to a method for controlling the light output from a laser when used in a light beam producing luminaire, specifically to a method relating to producing a wide, parallel beam, for controlling the size of that beam, and for including the output in a conventional automated luminaire.

### BACKGROUND OF THE INVENTION

It is well known to use lasers in luminaire designed for entertainment use in theatres, television studios, concerts, theme parks, night clubs and other venues. These lasers are also being utilized in systems with automated and remotely controllable functionality. However, a concern with all laser systems is the safety of the light emitted. Any high-powered system cannot be allowed to directly impinge on the eye of a viewer as it will damage the lens or retina. Further, the major feature of a laser beam is that it is narrow, and parallel (collimated). In some circumstances however, it would be advantageous if the light beam could remain collimated but be much wider. A wider beam has the advantage that it is more visible as a solid bar in the air, particularly if fog or haze is used, and that a wide beam will have a much lower power density and will consequently be much less dangerous.

For color control it is common to use an array of lasers of different colors. For example a common configuration is to use a mix of Red, Green and Blue lasers. This configuration allows the user to create the color they desire by mixing appropriate levels of the three colors. For example illuminating the Red and Green lasers while leaving the Blue extinguished will result in an output that appears Yellow. Similarly Red and Blue will result in Magenta, and Blue and Green will result in Cyan. By judicious control of these three controls the user may achieve any color they desire. More than three colors may also be used and it is possible to add an Amber or White laser to the Red, Green and Blue to enhance the color mixing and improve the gamut of colors available.

There is a need for a beam control system for a laser based luminaire that provides improvements in beam collimation, beam size adjustment, and safety.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates the functional design of an embodiment of a laser optical module from a multiparameter automated luminaire;

FIG. 3 illustrates a further embodiment of the optical design of the laser optical module with the optical elements in a position to generate a narrow (less widened) beam;

FIG. 4 illustrates a further embodiment of the optical design of the laser optical module with the optical elements in a position to generate a wider (more widened) beam;

FIG. 5 illustrates a further embodiment of the optical design of the laser optical module in relation to other optical subsystems of a multiparameter automated luminaire with the laser optical module in a disengaged mode;

FIG. 6 illustrates a the embodiment of the multiparameter automated luminaire in laser mode with the laser optical module in an engaged position; and

FIG. 7 illustrates an alternative embodiment of multiparameter automated luminaire in laser mode with the laser optical module in an engaged position.

### DETAILED DESCRIPTION OF THE INVENTION

Preferred embodiments of the present invention are illustrated in the FIGUREs, like numerals being used to refer to like and corresponding parts of the various drawings.

The present invention generally relates to a method for controlling the light output from a laser when used in a light beam producing luminaire, specifically to a method relating to producing a wide, parallel beam and for controlling the size of that beam and for providing the laser function as an accessory to an automated luminaire fitted with a conventional, non coherent, light source.

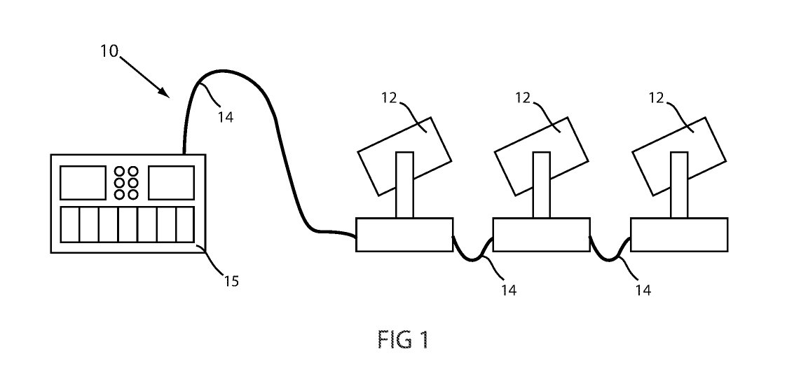

FIG. 1 illustrates a typical multiparameter automated LED luminaire system 10. These systems commonly include a plurality of multiparameter automated luminaires 12 which typically each contain on-board an array of LEDs, and electric motors coupled to mechanical drives systems and control electronics (not shown). In addition to being connected to mains power either directly or through a power distribution system (not shown), each luminaire is connected is series or in parallel to data link 14 to one or more control desk(s) 15. The automated luminaire system 10 is typically controlled by an operator through the control desk 15. Consequently, to affect this control, both the control desk 10 and the individual luminaires typically include electronic circuitry as part of the electromechanical control system for controlling the automated lighting parameters.

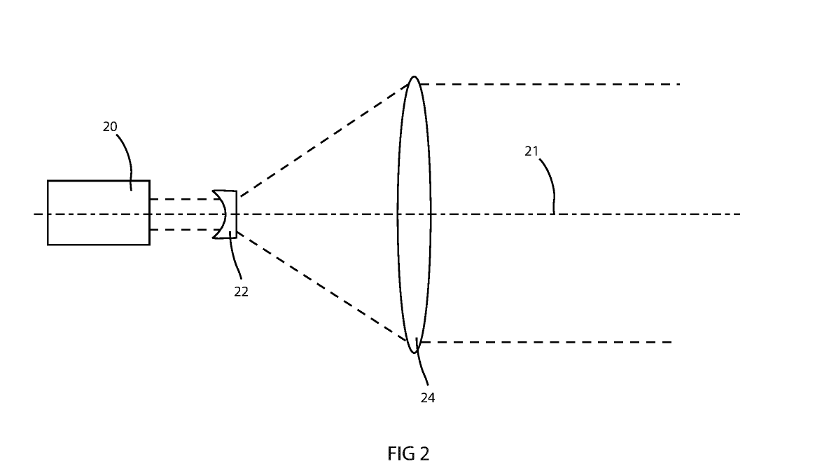

FIG. 2 illustrates an embodiment of the optical design of the invention; as fitted to an automated luminaire. Laser optical module 25 including Laser module 20, which emits a narrow collimated beam along optical axis 21 towards lenses 22, and 24. Lenses 22 and 24 act as a beam expanding system such that the output beam from the optical system remains parallel and collimated, but is significantly increased in diameter. The large parallel exit beam has a lower power density than the narrow input beam and is thus much safer for the audience. The system illustrated in FIG. 2 utilizes a negative lens, 22, and a positive lens, 24. However other optical systems using any number of lenses are possible without detracting from the intent of the invention. In particular, it is known to produce an alternative beam expanding optical system using two positive lenses. It is also possible to use holographic lenses or reflective systems to achieve beam expansion.

Laser module 20 may contain a single laser of a single color, or may contain an array of lasers in multiple colors, for example, red, green, and blue/violet lasers.

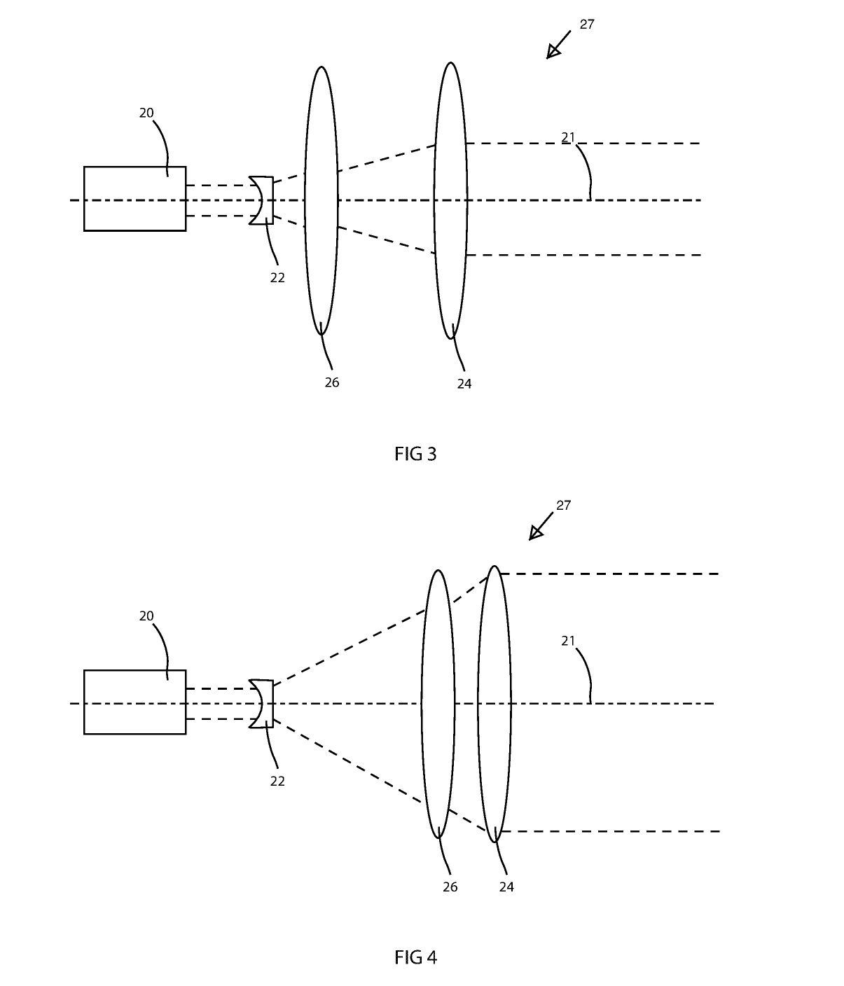

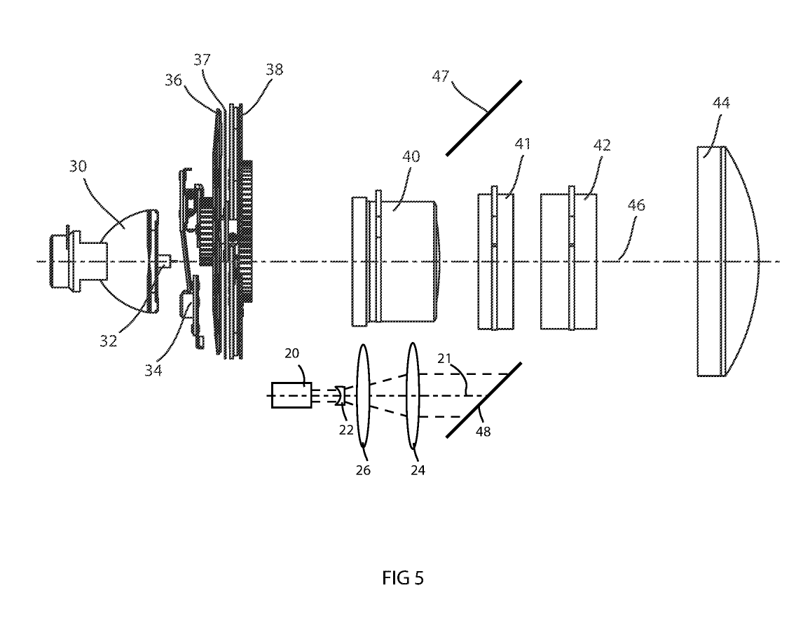

FIGS. 3 and 4 illustrate a further embodiment of the optical design of the invention; as fitted to an automated luminaire. Laser module 20 emits a narrow collimated beam along optical axis 21 towards lenses 22, 24, and 26. Lenses 22, 24, and 26 act as a beam expanding system such that the output beam from the optical system remains parallel and collimated, but is significantly increased in diameter. The large parallel exit beam has a lower power density than the narrow input beam and is thus much safer for the audience. In this embodiment one or more of lenses 22, 24, and 26 may be moved along the optical axis 21. This movement allows adjustment of the beam expansion of the optical system. In FIG. 3 lenses 22, 24, and 26 are adjusted such that the output beam is narrow (although still wider than the input beam) while in FIG. 4 lenses 22, 24, and 26 are adjusted such that the output beam is wide. The system illustrated in FIGS. 3 and 4 utilizes a negative lens, 22, and two positive lenses, 24, and 26. However other optical systems using any number of lenses are possible without detracting from the intent of the invention. It is also possible to use holographic lenses or reflective systems or a gradient beam splitter to achieve beam expansion.

The movement of one or more lenses 22, 24, and 26 along the optical axis and thus the amount of beam expansion may be achieved using stepper motors, linear actuators, servo motors, or other mechanisms as well known in the art.

Laser module 20 may contain a single laser of a single color, or may contain an array of lasers in multiple colors, for example, red, green, and blue lasers.

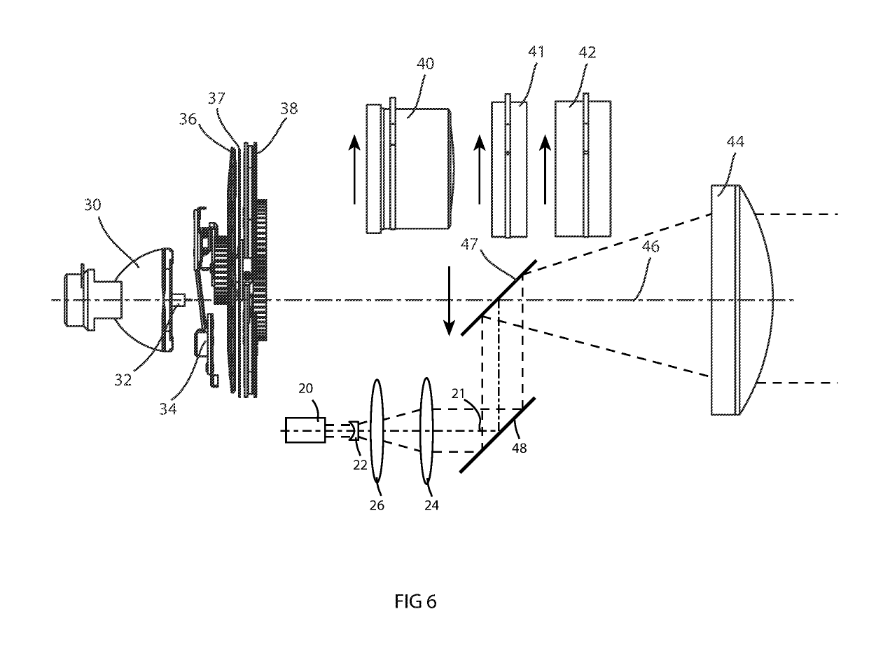

FIG. 5 illustrates an automated luminaire fitted with an embodiment of the invention as an accessory. The optical train of the automated luminaire comprises a conventional, non-coherent, light source 32 and reflector 30. Light is directed through optical components 34, 36, 37, and 38 which may comprise shutter modules, dimmer modules, gobo modules, color wheel modules, color mixing modules and other optical modules well known in the art. The light from these optical modules is then directed through lenses 40, 41, 42, and 44 any or all of which may move along first optical axis 46 in order to control the focus and divergence of the light beam. Although four lenses are herein illustrated, the invention is not so limited and any number of lenses with any number of them moving may be utilized as is well known in the art. Similarly, the invention is not limited to the type of light source 32 and reflector 30 illustrated. In practice any conventional, non-coherent, light source may be utilized including, but not limited to, HID lamps, incandescent lamps, plasma lamps, LEDs, OLEDs.

The automated luminaire may also be fitted with laser module 20 that emits a narrow collimated beam along second optical axis 21 towards lenses 22, 24, and 26. Lenses 22, 24, and 26 act as a beam expanding system such that the output beam from the optical system remains parallel and collimated, but is significantly increased in diameter. Light from the lenses is directed towards first mirror 48. In the position shown in FIG. 5, laser module 20 and its optical assembly is not being used and no light from the laser system will exit the luminaire.

FIG. 6 illustrates the automated luminaire shown in FIG. 5, with the system adjusted to utilize the laser module instead of conventional non-coherent light source 32. Lenses 40, 41, and 42 have been moved sideways, out of the optical path in the direction shown by the arrows. This provides space for second mirror 47 to be moved across the optical path such that it intersects the light exiting first mirror 48 from laser module 20. Light from laser module 20 and its associated beam expanding optics 22, 24, and 26 now reflects from first mirror 48 and second mirror 47 such that it is diverted from second optical axis 21 to first optical axis 46. It subsequently passes through output lens 44 that now forms the final lens of the beam expanding optical system. The light beam exiting lens 44 may be substantially parallel and collimated with a large and adjustable diameter. In the position shown in FIG. 6, conventional non-coherent light source 32 is not being used and no light from light source 32 will exit the system. Movement of lenses 40, 41, and 42 and second mirror 47 may be through servo motors, stepper motors, linear actuators or other mechanical means well known in the art. In particular moving systems may be mounted on tracks or on arms that can be rotated into position.

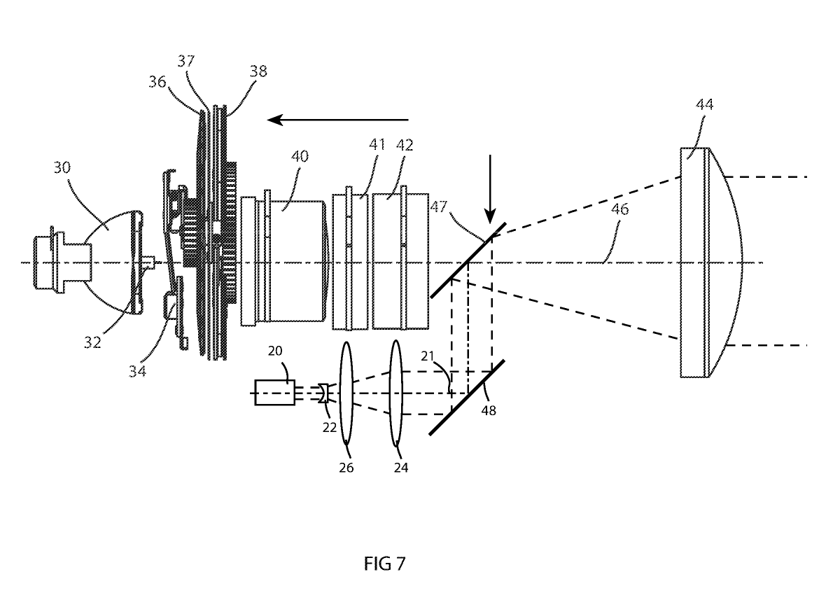

FIG. 7 illustrates an alterative embodiment of the automated luminaire shown in FIG. 5, with the system adjusted to utilize the laser module instead of conventional non-coherent light source 32. In this embodiment lenses 40, 41, and 42 have been moved backwards, along the optical path in the direction shown by the arrow towards optical modules 34, 36, 37, and 38. This provides space for second mirror 47 to be moved across the optical path such that it intersects the light exiting first mirror 48 from laser module 20. Light from laser module 20 and its associated beam expanding optics 22, 24, and 26 now reflects from first mirror 48 and second mirror 47 such that it is diverted from second optical axis 21 to first optical axis 46. It subsequently passes through output lens 44 that now forms the final lens of the beam expanding optical system. The light beam exiting lens 44 may be substantially parallel and collimated with a large and adjustable diameter. In the position shown in FIG. 7, conventional non-coherent light source 32 is not being used and no light from light source 32 will exit the system. Movement of lenses 40, 41, and 42 and second mirror 47 may be through servo motors, stepper motors, linear actuators or other mechanical means well known in the art. In particular moving systems may be mounted on tracks or on arms that can be rotated into position. In some embodiments, second mirror 47 may be a conventional mirror reflecting the color wavelength(s) of the laser or it may be a dichroic or interference filter designed to reflect those wavelengths at the angle of incidence of the laser light beam on the mirror. In further embodiments the first mirror 46 may be of similar selection/design.

By use of such an accessory laser system the utility and effectiveness of an automated light may be substantially improved. The output paths of the laser light source and the conventional light would be integrated in that their output beam axes would be substantially shared or the same. The lighting operator may choose to use either the conventional, non-coherent, light source or a coherent light source as desired. Switching from one system to the other, and the control of all lens and mirror movements may be achieved remotely through the existing control system within the automated luminaire.

The system described, or variants, may be fitted to existing automated luminaire types such as spot, wash, or beam without interfering with their normal use.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. An automated multiparameter luminaire with a main output comprising:
a laser optical module generating a directed laser light beam of variable beam width;
an conventional light engine optical module for multiparameter modulation of a conventional light beam;
an laser beam positioner which can integrate the widened laser beam into the path of the conventional light beam through the main of the multiparameter luminaire.

2. The luminaire of claim 1 where the laser beam positioner includes a mirror articulated to enter the light beam path in order to integrate the laser beam into the path of the conventional light beam or removed from the light beam path.

3. The luminaire of claim 1 where the laser beam positioner includes a mirror which is an interference filter designed to reflect the wavelength(s) of the laser at their angle of incidence on the mirror.

4. The luminaire of claim 2 where at least some conventional light modulation components are also articulated to make room for said mirror.

5. The luminaire of claim 4 where the articulation of the conventional light modulation components moves the components out of the path of the conventional light beam in the light engine.
